(19) United States
(12) Patent Application Publication
(10) Pub. No.: US 2004/0096578 A1
(43) Pub. Date: May 20, 2004

(54) Method and system for fabricating window coverings

(75) Inventor: Felton Thomas Colwell, Minnetonka, MN (US)

Correspondence Address: Merchant & Gould P.C., P.O. Box 2903, Minneapolis, MN, 55402-0903, US

(73) Assignee: Colwell Industries, Inc.

(21) Appl. No.: 10/706,490

(22) Filed: Nov. 11, 2003

Related U.S. Application Data
(60) Provisional application No. 60/426,331, filed on Nov. 13, 2002.

(51) Int. Cl. B05D 5/06

(52) U.S. Cl. 427/162; 427/256

(57) ABSTRACT

A method and system for fabricating window coverings by receiving orders for custom-colored window coverings, formulating a layout for cutting bulk window covering material to accommodate the orders, cutting the bulk window covering material according to the layout and then applying the desired color to the cut material is disclosed. The desired color may be applied by converting the color information to a mathematical address, mixing inks to provide ink according to the mathematical address and applying the mixed ink to a blank window covering.

### CROSS REFERENCE TO RELATED APPLICATION

This application claims the benefit of U.S. Provisional Application Serial No. 60/426,331, filed Nov. 13, 2002 entitled “METHOD AND SYSTEM FOR FABRICATING WINDOW COVERINGS”, which application is incorporated by reference herein.

### FIELD OF THE INVENTION

The invention relates generally to fabricating window coverings, and more particularly to a method and system for fabricating custom-colored window coverings.

### BACKGROUND

The alternative window coverings (“AWC”) industry provides soft and hard window treatments to customers desiring window coverings other than conventional draperies. Hard window treatments include faux wood and wood horizontal blinds, vinyl and metal horizontal blinds, vertical blinds and interior shutters. Soft window treatments include cellular shades, pleated shades, roller shades, soft shades, vertical blinds and soft window shadings.

AWC products are offered to customers through a variety of retail channels, including home product centers, independent retailers, discount department stores, retail fabricators, department stores, catalogs, internet, home builders and interior designers and decorators. About twenty percent (20%) of the total sales volume in the AWC industry represents products sold from retail stock, i.e., ready-made products. The balance of the sales volume is made up of custom-made product purchases. Typically, custom-made products are manufactured by a wholesale fabricator or a retail fabricator and then are sold either directly to customers or to a retail source that, in turn, sells the completed product to the customer.

Various vendors provide components of window coverings to the fabricators, who then assemble the components into completed products. The inventory provided by vendors can include manufactured bulk window covering material and the hardware used to install and operate the window covering after installation. The bulk window covering material can be manufactured from a variety of raw paper formulations, textiles, woven or non-woven fabrics and synthetic materials. The vendor produces bulk paneled window covering material which is dyed or printed based on the vendor's established line of colors (or “color collection”) and shipped to fabricators.

A customer desiring a custom-made window covering typically places an order with a retail source, specifying the features of the finished product desired. Such features can include information about the size of the window, the style, the desired color and various additional options including the type of hardware to be included for mounting and controlling the window covering after installation. The retail source passes the order along to the fabricator. Upon receiving the order, the fabricator cuts the pre-colored bulk material into the size specified by the customer and adds the desired hardware to produce the custom window covering. The completed product is then sold directly to the customer and/or shipped to the retail source.

Fabricators who agree to carry a particular vendor's collection are often required to purchase pre-colored bulk window coverings of every color in the collection in order to be able to service orders in a timely manner. This, in turn, requires fabricators to have adequate storage and tracking procedures for storing and tracking the bulk material, as well as the remnants produced during the fabrication process.

The conventional fabrication process offers customers a finite number of color choices for window coverings because colors must be selected from a given vendor's color collection. Therefore, a customer desiring window coverings is forced to choose a color that either coordinates with his or her home decor or merely “comes close.”

The conventional fabrication technique has additional disadvantages for the fabricator. Notable drawbacks include wasted inventory due to the generation of scrap material in the manufacturing process and obsolescence of inventory due to changes in manufacturer color lines. The cost of this wasted inventory is typically absorbed by the fabricator. Failure to use purchased inventory typically results in 30 to 50% waste and can add as much as 20-35% to the cost of producing the AWC product. In addition, fabricators are currently required to carry inventory corresponding to all colors in a manufacturer's product line, which averages about 250 colors. The inventory investment for fabricators is therefore often substantial, as are the storage requirements inherent in carrying a manufacturer's collection of window coverings.

Thus, it would be advantageous to be able to fabricate and offer an unlimited number of color choices in alternative window coverings. In this manner, customers would have the option of matching other home products such as carpet and paint, or providing a color sample that can be matched exactly. It is also desirable to reduce inventory waste and up-front investment and storage requirements that are inherent in conventional methods of manufacturing alternative window coverings

### SUMMARY OF THE INVENTION

The present invention provides a method and system for fabricating window coverings that provides vast color options for the customer. The present invention also provides for reduced production costs for the fabricator based on a reduction of wasted colored AWC material, reduced investment and inventory costs, and reduced storage requirements.

In a preferred system and method in accordance with the principles of the present invention, the fabrication of window coverings involves the sequential steps of receiving orders for custom-colored window coverings, formulating a layout for cutting bulk window covering material to accommodate the orders, cutting the bulk window covering material according to the layout and then applying the desired color to the cut material.

Additional methods of providing custom-colored window coverings according to the invention are described. One method includes receiving an order for a custom-colored window covering which includes color information, converting the color information to a mathematical address, mixing inks to provide ink according to the mathematical address and applying the mixed ink to a blank window covering.

A further method includes the steps of receiving an order for a custom-colored window covering which includes a physical color sample, mixing inks to match the color sample and applying the mixed ink to a blank window covering.

A preferred method of extending a product line is described which involves providing custom-colored window coverings and cross-marketing the custom-colored window coverings with home improvement products. Home improvement products include paints, floor coverings, fabrics, furnishings, home accessories, wall-coverings and soft window treatments.

While the invention will be described with respect to a preferred embodiment method and system of fabricating alternative window coverings and with respect to particular steps used therein, it will be understood that the invention is not to be construed as limited by the preferred embodiments described. Numerous modifications, variations, and equivalents will occur to those skilled in the art without departing from the spirit and scope of the present invention as defined by the appended claims.

### BRIEF DESCRIPTION OF THE DRAWINGS

FIG. 1 is a flow chart depicting a general overview of a fabrication method in accordance with the present invention.

FIG. 2 is a flow chart depicting a preferred fabrication method in accordance with the present invention.

FIG. 3 is a representational drawing of the prior art fabrication method.

FIG. 4 is representational drawing of a fabrication method according to the present invention.

FIG. 5 is a logic flow diagram of the steps which may be implemented by a computer at block 25 of FIG. 2 to optimize the layout.

FIG. 6 is a functional block diagram of the components utilized in connection with a preferred embodiment of the present invention.

### DETAILED DESCRIPTION

The present invention is directed to a method and system for fabricating alternative window coverings. In general, the invention allows for the fabrication of custom-made window coverings of any color desired by the customer and provides reduced storage and investment requirements for fabricators. This invention, provides for a novel fabrication method and system in which blank uncolored bulk window covering material is first cut, and then colored, to provide a custom-sized window covering of any color desired by a customer.

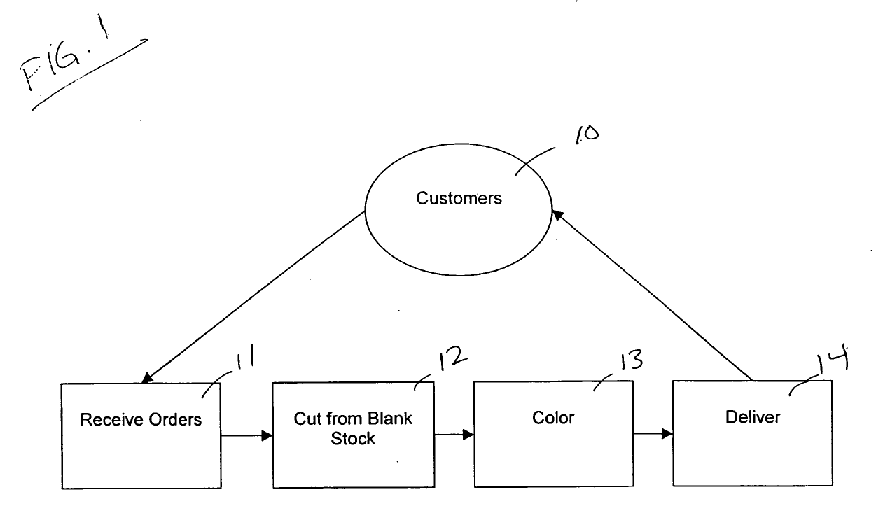

With reference to FIG. 1, a preferred method. In accordance with the principles of the present invention is illustrated. The method provides a system in which custom window coverings are produced by fabricators. In an initial step, the fabricator receives orders 11, either directly from customers 10 or from a retail source. Orders can be received via any known information transmittal system, including but not limited to telephone, mail, e-mail, facsimile, internet, direct dial-up computer connection, and/or other well known communication mediums.

After receiving orders 11, the fabricator then cuts 12 appropriately styled blank bulk window covering material according to the orders. “Blank bulk window covering material,” as used herein, includes any window covering material to which color is to be applied. In a preferred embodiment, blank material is a neutral color. Non-exhaustive examples of neutral colors are natural, cream, white and off-white. In a most preferred embodiment, the blank window covering material is uncolored. The bulk material is generally provided by vendors or manufactured on site by the fabricator as a large panel of material that can accommodate more than one, and preferably many, orders. As used herein, “cutting” refers to any hand or automated process for cutting bulk window covering material to produce appropriately sized window coverings according to the size specified in the order; The cutting apparatus can include knives, blades, scissors, die rule stamps, roller knives, rotary blades, cutting wires, lasers, water jets, and other well known cutting techniques and apparatus. The cutting apparatus may be manually implemented and or automated (e.g., an automated X-Y table).

In a subsequent step, color is applied at block 13 to the cut window covering material. “Applying color,” as used herein, refers to spraying, brushing, rolling, pad coating, curtain coating, inkjet printing, silkscreen printing, dying and/or other coloring techniques. The application process can be manual or automated. Color can be applied to either or both of the front and back surfaces of a window covering panel. It will be appreciated by those of skill in the art that different colors may also be applied to the front and back of the cut window material. Further, the applications can include those having different optical properties. For example, an opaque application can be placed on a covering to shield the covering from the sun's rays, while the front can be the desired color.

After various other optional modifications are made to the colored, sized window covering, including the addition of hardware for mounting and controlling the panels after installation, the completed product is delivered 14.

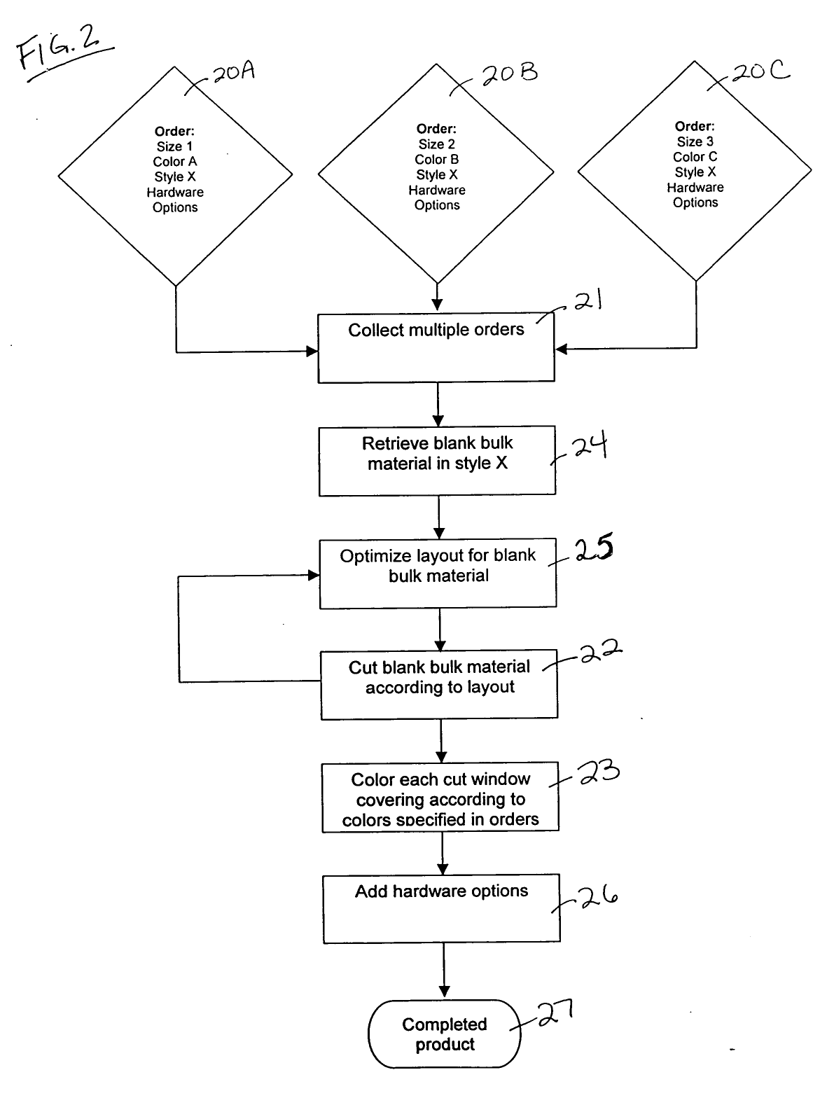

With reference now to FIG. 2, a more detailed functional step diagram according to the invention is illustrated. First, the fabricator collects multiple orders at block 21. The orders at blocks 20A, 20B, and 20C can include preferably at least size information, color information, style information and hardware options. “Size information,” as used herein, refers to measurements of the window for which the customer desires window coverings, or specific measurements for a window covering. Optionally, “size information” can include shape of a window to be covered by a window covering. “Color information,” refers to the color desired by the customer. Color information can include identification of a home improvement product manufacturer's color. A non-exhaustive list of home improvement products include paint, carpet, wallpaper, fabric, tile, and linoleum. In an alternative embodiment of the invention, “color information” can also refer to a physical sample that is provided by the customer. Physical samples can include, for example, paint chips, fabric swatches, papers, stained or painted materials, tiles, samples of linoleum, photographs or virtually any physical item that is a color the customer wishes to match. “Style” refers to type of window covering. Non-exhaustive examples of window covering styles include roller shades, cellular shades, double cellular shades, triple cellular shades, soft shades, pleated shades and vertical blinds.

Next at block 24, the fabricator retrieves blank bulk material in the style specified in the orders received. For example, multiple orders received for double honeycomb blinds would result in the retrieval of bulk double honeycomb blind material.

Next, at block 25, a layout is formulated and, in a preferred embodiment, optimized. As used herein, “formulating a layout” includes, but is not limited to, making a visual determination of an appropriate layout or using software constructed to indicate an appropriate layout. “Optimized,” as used herein, refers to a layout that is formulated to produce the smallest possible remnant, or no remnant at all. The layout incorporates all sizes ordered for a particular style bulk panel, which is then cut according to the layout at block 22. If any material remains (e.g., due to incomplete use of the bulk material), the remnant can be stored and then retrieved after receipt of additional orders for that style.

Subsequently, each cut window covering is colored according to the orders at block 23. Coloring can include mixing different colored pigments to produce the desired color and applying the color to the cut window covering. It will be appreciated by those of skill in the art, however, that the colors can be premixed. In that event, the colors are specified for application to the material without a mixing step. “Mixing different colored pigments,” as used herein, refers to any manual or automated process known in the art for combining two or more colored pigments to produce a desired color. “Pigment” refers to a substance that imparts color to a material. Non-exhaustive examples include inks, paints, dyes and stains.

It may be preferred to color the window coverings with an ink-paint. This combination preferably provides the absorbency of ink with the coverage of paint. Functional characteristics include flexibility, coverage, adherence to the window covering, and non-fading, among others. Depending on the style of the window covering, the application of the color may preferably be performed with the window covering laid and/or stretched flat to obtain uniform coverage. The drying step may not require being flat. Also depending on the style of the window covering, a reheating and resetting of pleats may be required.

To complete the product, the hardware options are added at block 26 and the window covering is shipped to the customer at block 27.

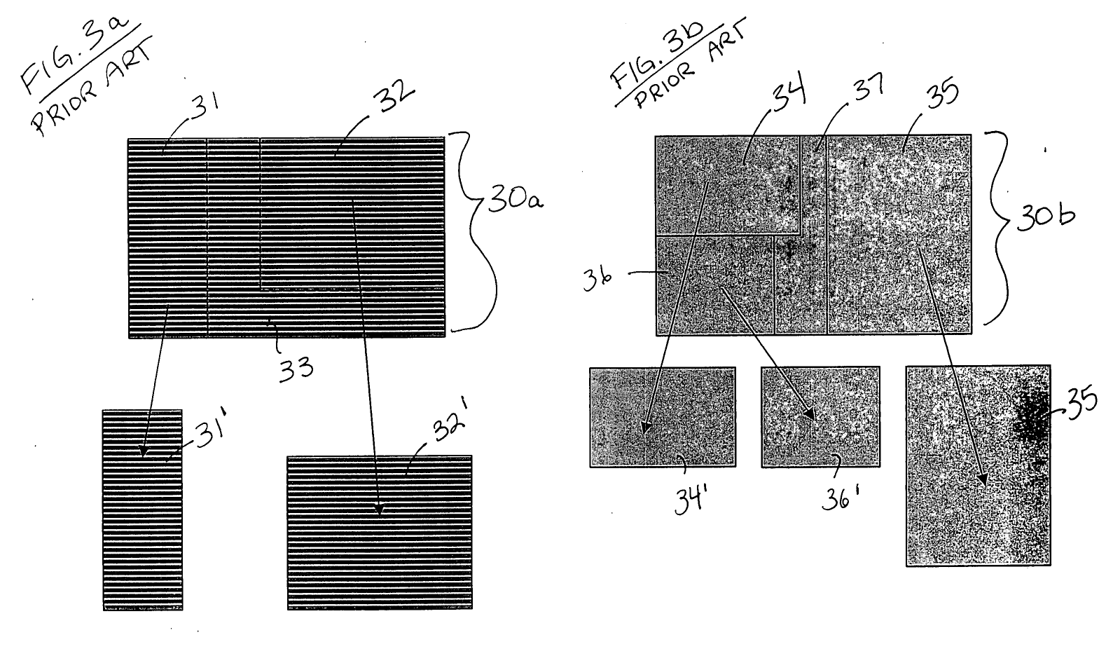

FIGS. 3a and 3b depict the prior art fabrication method. Pre-colored bulk window covering material 30b and 30b is sized and cut according to orders received for specific colors in the manufacturer's color line. In FIG. 3a, a pre-colored bulk material 30b has two coverings laid out (e.g., 31 and 32). The window coverings are then cut from the bulk material 30b and are designated at 31′ and 32′. It will be appreciated that a substantial remnant 33 is generated via this process. In FIG. 3b, a different pre-colored bulk material 30b has three coverings laid out (e.g., 34, 36, and 35). The window coverings are then cut from the bulk material 30b and are designated at 34′, 35′, and 36′. In this example, substantial remnant 37 is generated. The remnants 33 and 37 must be stored until additional orders are received if large enough to accommodate additional orders, or must be scrapped if too small or oddly shaped to accommodate additional orders. In addition, upon discontinuation of the color by the manufacturer any remnants 33, 37 and even whole panels of bulk unused material must be scrapped as waste if the manufacturers discontinues color lines.

It will be appreciated that the preceding two examples are merely representative of situations in which remnants are generated. The actual sizes of the remnants will vary based on the orders received and the physical sizes of the orders relative to the bulk material, among other factors.

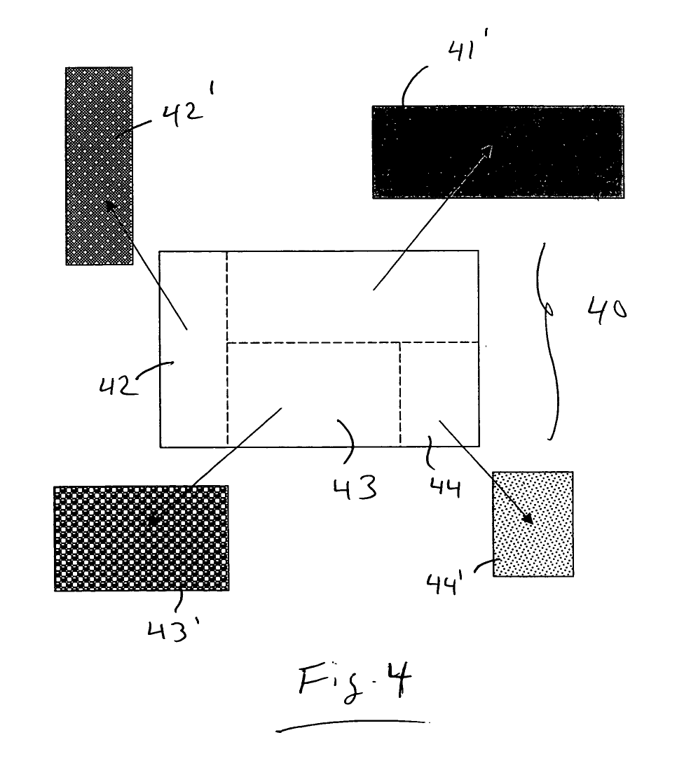

In contrast, however, FIG. 4 depicts a preferred method of the invention which provides for less wasted material. The blank bulk material 40 of a particular style is optimized according to size only. The pre-cut window coverings 41, 42, 43 and 44 are then colored according to orders to produce custom-colored and sized window coverings 41′, 42′, 43′ and 44′ with little or no waste. It is noted that no waste is depicted in FIG. 4. However, in some instances, waste will occur depending on the orders received and the resulting fit of the orders. In addition, no waste is ever generated due to manufacturer color line discontinuances.

One embodiment of the method of the present invention allows the customer to provide color information derived from any existing manufacturer color line for any home products. Manufacturer information for window treatments, paints, wallpapers, fabrics, carpets, tiles, or any home improvement product, can be provided to the fabricator. The fabricator can use a database of known colors to generate the desired color via manual or automated processes known in the art.

Another embodiment of the invention described herein utilizes automated processes of color matching that are known in the art. One such process, described in U.S. Pat. No. 5,012,431 and incorporated herein by reference, allows for generating a mathematical address for a set of color characteristics that indicates the reflectance of each color. Output generated provides for automated or manual mixing of pigments, dyes or inks to generate the desired color. This type of color matching, referred to optical color matching or L*a*b* color matching, can be used if the customer desires a custom color and provides a physical sample.

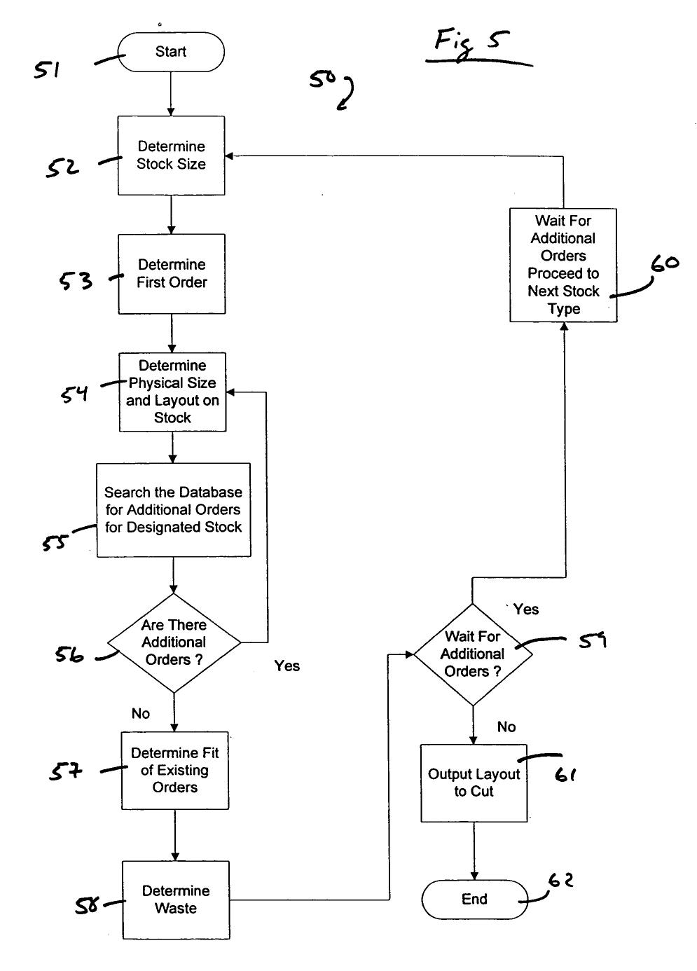

Next turning to FIG. 5, a logic flow diagram of the steps which may be implemented by a computer at block 25 of FIG. 2 to optimize the layout is presented. The flow diagram is illustrated generally at 50. The process starts at block 51 and proceeds to block 52 where the processor determines the current non-colored bulk material size. Moving to block 53, the processor determines the first order. At this step, the size and other physical characteristics of the window covering is determined. Next at block 54, the physical size of the first order is provisionally laid out on the stock materials. Proceeding then to block 55, the processor searches the database (described further below) whether there are additional orders for the designated stock. It will be appreciated that stock in this context refers to the type of window covering rather than to a particular color window covering.

At block 56, the processor determines whether there were additional orders in the database. If the answer is “yes”, then the processor returns to block 54 and lays out the additional order on the stock. At this step, the layouts are optimized in accordance with available software programs, through mathematical algorithms, and/or trial and error. This process repeats for each additional order in the database. Once there are no additional orders, the processor proceeds to block 57 to determine whether the optimized fit is within a given range. At block 58, the waste is determined given the fit of the existing orders. It will be appreciated that in the preferred embodiment the percentage of waste may be set based on the fabricator's tolerance for wasted material. In addition, the timing or urgency of the order may be considered. Also, if the determined waste exceeds a certain threshold, then the operator can be flagged to manually determine whether the operation should proceed. At block 59 these processes occur and if the answer is that additional orders should be found prior to cutting, due to wastage or other concerns, the process proceeds to block 60 to wait for those orders and/or to proceed to the next type stock.

If the waste is non-existent or below the given threshold, then the process can proceed from block 59 to block 61 to output the layout to cut the stock. At block 62, the process ends.

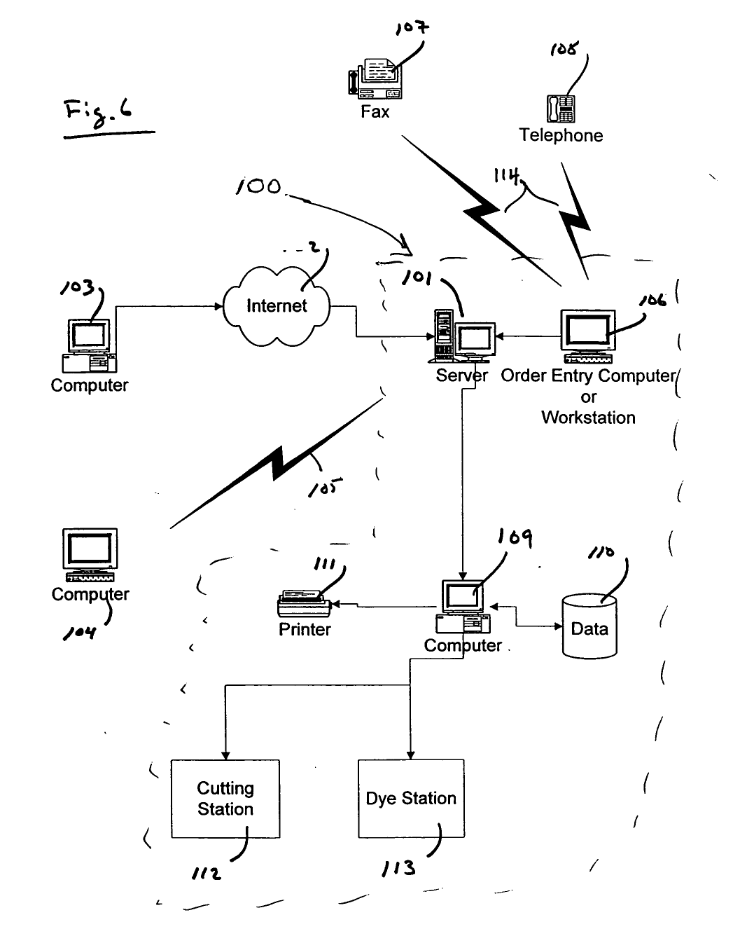

Turning to FIG. 6, a functional block diagram of the components utilized in connection with the preferred embodiment is presented. In FIG. 6, the system is illustrated generally at 100. The computer 109 may be of the Pentium® based PC compatible type and can include a Windows® operated software or the like. A computer operates in a well know manner and may be attached to an output device such as printer 111, monitors, and other devices. The computer includes input devices such as a mouse, track ball, keyboard (not shown) among other input devices. The computer includes a database 110 to include received orders, color space data, pigment formulations, and other information. Computer 109 is connected to a server 101 which acts as an entry point to the system for orders from a variety of sources. The server can collect orders from retailers and other commercial entities via a direct connection computer 104 via a dial up modem or the like over a line (designated at 105). The access may be via the Internet 102 by computer 103 or via facsimile 107 and telephone 108 over communication lines 114. In the latter case, order entry computer may be located at the fabricator with an operator accepting the orders and entering the orders on workstation or computer 106. The computer 109 sets the orders from the server 101 and stores the same in the database 110. As described above in connection with FIG. 5, computer 109 collects the orders, optimizes the layout, and provides output instructions to the cutting station 112 and dye station 113 to fabricate the window treatments.

The following non-limiting examples are hypothetical scenarios that may be encountered by a typical window covering customer under the prior art and the present invention.

### EXAMPLE 1

### Prior Art

A customer paints his living room with Glidden® Simmering Cider #50YR26461. Unable to find this shade among existing window covering vendor color collections, the customer measures his living room window and places an order for a custom made cellular shade in a coordinating neutral color.

### EXAMPLE 2

### Customer Seeks Cellular Shade to Match Interior Paint

A customer paints his living room with Glidden® Simmering Cider #50YR26461. Unable to find a suitable shade among existing window covering vendor color collections, the customer measures his living room window and places an order for a custom colored cellular shade in Glidden® Simmering Cider #50YR26461.

### EXAMPLE 3

### Customer Seeks Cellular Shade to Match a Physical Object

A customer purchases a painting by a local artist. The painting contains a shade of green that the customer particularly likes. Unable to find this shade among existing window covering vendor color collections, the customer measures his living room window and photographs the painting. The customer places an order for a custom made cellular shade and includes the photograph, with an indication of the shade of green in the painting desired for the cellular shade.

The following non-limiting examples are scenarios faced by fabricators in the AWC industry under the prior art and the present invention.

### EXAMPLE 4

### Prior Art

A fabricator agrees to carry the full line of Manufacturer X's pleated shades. Manufacturer X requires the fabricator to have on hand at least one entire full box of bulk material of each of its 175 colors. The fabricator makes a sizable initial investment and is required to rent nearby warehouse space to store the bulk material. As orders come in and the stock material is cut, the remnants must also be stored. Some of the more popular colors are eventually substantially used as customer and retailer orders are placed and filled. The less popular colors are barely used and some colors are not used at all. Two years later, Manufacturer X discontinues 50% of its line of colors and the fabricator is forced to absorb the investment for all material that is wasted.

### EXAMPLE 5

### Fabricator Purchases only Blank Bulk Window Covering Material

A fabricator agrees to purchase all bulk material for pleated shades from a single vendor. The fabricator purchases an L*a*b* color match system and chooses an ink vendor. The fabricator also uses the L*a*b* system to create and compile a database of mathematical addresses for manufacturer colors for home improvement products, including carpets and interior paints. The fabricator orders bulk material monthly, with typical sales volume in mind. Only the amount used to fill orders in a typical month must then be stored.

Each day, upon receiving customer orders, the fabricator uses software that formulates a layout to optimize usage and minimize waste of blank bulk material. The blank bulk material is cut according to the layout into the individual sized specified in the day's orders. The specified colors are created either from the database or, when a customer provides a physical sample, from the optical color match system. The colors are then applied to the pre-cut shades and the specified hardware options are added. The finished orders are shipped to the customers.

### EXAMPLE 6

### Extension of a Product Line

Manufacturer X, a window shade vendor, and Glidden, an interior paint vendor, approach a fabricator to supply custom-made shades in each of the colors in Glidden's collection. The companies cross-market their products.

It will be appreciated that the principles of this invention apply not only to the particular embodiments described with particularity herein, but also to embodiments that encompass the spirit and intent of this invention. Other modifications and alterations that are within the knowledge of those of skill in the art are to be included in the broad scope of the appended claims.

What is claimed is:

1. A method of fabricating window coverings, comprising the sequential steps of:
a) receiving orders for custom-colored window coverings;
b) formulating a layout for cutting blank bulk window covering material to accommodate the orders;
c) cutting the bulk window covering material according to the layout; and
d) applying color to the cut material;
wherein the window covering material has a front surface and a back surface.

2. The method of claim 1, wherein two colors are applied to the cut material.

3. The method of claim 1, wherein the window coverings are cellular fabric, a woven fabric or a non-woven fabric.

4. A method according to claim 1 wherein the orders include size, style and color information.

5. A method according to claim 1 further comprising the step of installing hardware.

6. A method according to claim 1 wherein receiving orders comprises receiving orders over an internet connection, by facsimile, by mail or by telephone.

7. A method according to claim 1 wherein the bulk window covering material comprises a neutral-colored material.

8. A method according to claim 1 wherein formulating a layout comprises optimizing the layout.

9. A method according to claim 8 wherein optimizing the layout comprises using software constructed to create an optimum layout.

10. A method according to claim 8 wherein optimizing the layout comprises making a visual determination to create an optimum layout.

11. A method according to claim 1, wherein applying color to the cut material comprises an application method selected from the group consisting of spraying, brushing, rolling, pad coating, curtain coating, inkjet printing, silkscreen printing and dying.

12. A method according to claim 1, wherein applying color to the cut material is accomplished manually.

13. A method according to claim 1, wherein applying color to the cut material is accomplished by an automated X-Y table.

14. A method according to claim 1, wherein applying color to the cut material comprises applying color to only one surface of the material.

15. A method according to claim 1, wherein applying color to the cut material comprises applying color to the front and back surface of the material.

16. A method according to claim 15, wherein there is a first color applied to the front surface of the material and a second color applied to the back surface of the material, and wherein the first and second colors are different.

17. A method according to claim 16, wherein the first color and the second color are constructed of materials having differing optical properties.

18. A method according to claim 1, wherein the window covering material comprises a woven, knit or non-woven material.

19. A method according to claim 8, wherein the non-woven materials include a nonwoven polyester materials or a synthetic material.

20. A method of providing custom-colored window coverings, comprising the steps of:
a) receiving an order for a window covering, wherein the order includes a physical sample for color-matching;
b) mixing different colored inks to provide ink to match the physical sample provided in the order;
c) applying the ink to a window covering to provide a custom-colored window covering.

21. A method of providing custom-colored window coverings, comprising the steps of:
a) receiving an order for a window covering, wherein the order includes color information;
b) converting the color information to a mathematical address;
c) mixing different colored inks to provide ink comprising a custom color according to the mathematical address;
d) applying the ink to a neutral-colored, window covering to provide a custom-colored window covering.

22. The method according to claim 21, wherein converting the color information comprises using an L*A*B* color match system to convert a color to a mathematical address.

23. The method according to claim 21, wherein converting the color information comprises retrieving a mathematical address for the color from an electronic database.

24. A method of extending a product line comprising:
a) providing custom-colored window coverings according to the method of claim 19;
b) cross-marketing the custom-colored window coverings with home improvement products selected from the group consisting of: paints, floor coverings, fabrics, furnishings, home accessories, wall-coverings and soft window treatments.
